(19) United States
(12) Patent Application Publication
(10) Pub. No.: US 2003/0112218 A1
(43) Pub. Date: Jun. 19, 2003

(54) Data processing system input pointing device including means and method for controlling audio output

(75) Inventors: Lane Thomas Holloway, Pflugerville, TX (US); Nadeem Malik, Austin, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 10/006,077

(22) Filed: Dec. 6, 2001

(51) Int. Cl. G09G 5/00

(52) U.S. Cl. 345/156

(57) ABSTRACT

A data processing system input pointing device is described. The input pointing device includes a control device on a side of the device. The control device may be used to control an audio output of the data processing system in response to a movement of the control device.

### TECHNICAL FIELD

The present invention relates generally to data processing systems, and more particularly to input pointing devices for inputting data into data processing systems. Still more particularly, the present invention relates to a data processing system input pointing device having a control device for controlling an audio output of the data processing system in response to a movement of the control device.

### DESCRIPTION OF RELATED ART

Input devices, such as keyboards, are utilized to input data into a computer system. The use of an input pointing device, such as a mouse or joystick, simplifies many computer operations. Although keyboards are input devices, they are not considered “input pointing devices”.

It is known to include a cursor control device on either a keyboard or a mouse. The cursor control device is a joystick-type control capable of moving a cursor. Such a cursor control device is known as a “Trackpoint™”. Trackpoint™ is a trademark of International Business Machines Corporation.

It is also known to include a scroll device on a top of a mouse. The scroll device is capable of scrolling the screen currently being displayed. A scroll device controls scrolling and does not change the current position of the cursor.

A user may utilize a keyboard in order to change the audio output of the data processing system. On some keyboards, a volume control device is included on top of the keyboard. The volume control device may be implemented as a rocker switch which when depressed on the top of the switch will increase the volume, and when depressed on the bottom of the switch will decrease the volume. Additional knobs have been included along with the volume switch which are separate from the volume switch. The additional knobs may be used to play an audio selection, pause the current selection, jump to the next audio selection, or jump back to the previous audio selection.

In order to use the keyboard audio control devices if the user is currently using the mouse, a user must lift his/her hand from the mouse and then manipulate the appropriate knob(s). A user typically uses the mouse to select an audio file to be heard and to perform other functions. For example, the user may use the mouse to select the desired function from a control screen displayed on the computer screen. The user may then use the mouse to move the cursor to the desired function, and then select the function to control the audio output.

When the user wishes to control the audio output, the user must either use the mouse to move the cursor to the appropriate function or the user must move his/her hand back to the keyboard. It can become very inconvenient to continue to jump back and forth between the mouse and the keyboard.

Therefore, a need exists for a data processing system input pointing device that includes a single control device for controlling an audio output of the data processing system.

### SUMMARY OF THE INVENTION

A data processing system input pointing device is described. The input pointing device includes a single control device on a side of the device. The control device may be used to control an audio output of the data processing system in response to different movements of the control device.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is pictorial representation of a distributed data processing system in which the present invention may be implemented;

FIG. 2 is a block diagram of a data processing system which may be implemented as a server in which the present invention may be included in accordance with the present invention;

FIG. 3 is a block diagram of a data processing system which may be implemented as a client in which the present invention may be included in accordance with the present invention;

FIG. 4 is a side view of a mouse which includes an audio control device in accordance with the present invention;

FIG. 5 is a top view of the mouse of FIG. 4 in accordance with the present invention; and

FIG. 6 is a high level flow chart which depicts utilizing an audio control device included within a mouse in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is an input pointing device including an audio control device for controlling an audio output of the data processing system. Preferably, the present invention is implemented as a single audio wheel include on the side of a mouse. The single audio wheel may be used to increase the volume of the audio output, decrease volume, toggle a mute on and off, fast forward through a current audio selection, and rewind through a current audio selection. All of the functions are provided through the single audio wheel.

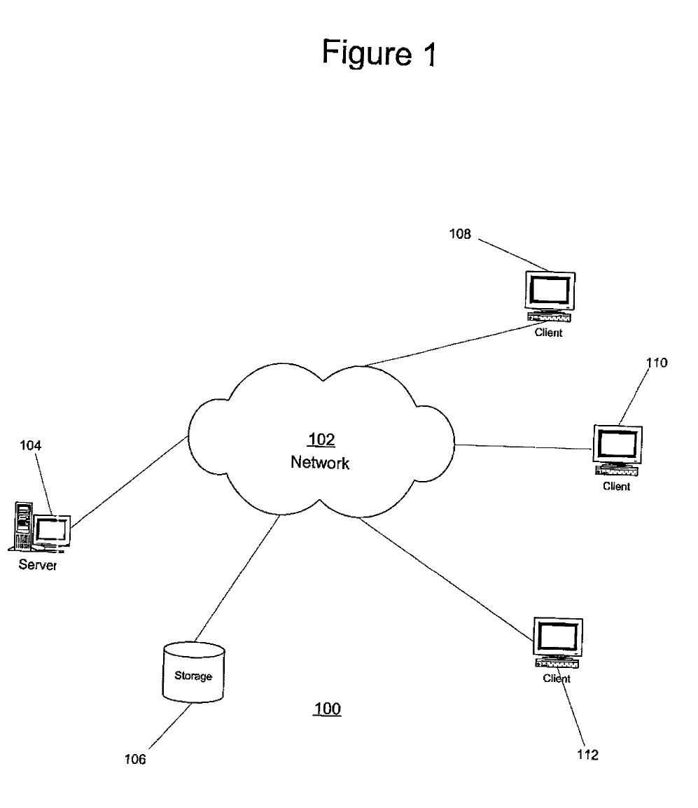

With reference now to the figures, and in particular with reference to FIG. 1, a pictorial representation of a distributed data processing system is depicted in which the present invention may be implemented. Distributed data processing system 100 is a network of computers in which the present invention may be implemented.

Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110, and 112 are also connected to network 102. These clients, 108, 110, and 112, may be, for example, personal computers, network computers, personal digital assistants, data network compatible cellular devices, cable or satellite TV set-top boxes, Internet ready game consoles, and the like. For purposes of this application, a network computer is any computer coupled to a network which receives a program or other application from another computer coupled to the network. In the depicted example, server 104 provides data, such as boot files, operating system images and applications, to clients 108-112. Clients 108, 110, and 112 are clients to server 104. Distributed data processing system 100 may include additional servers, clients, and other devices not shown.

Distributed data processing system 100 may be the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network. FIG. 1 is intended as an example and not as an architectural limitation for the processes of the present invention.

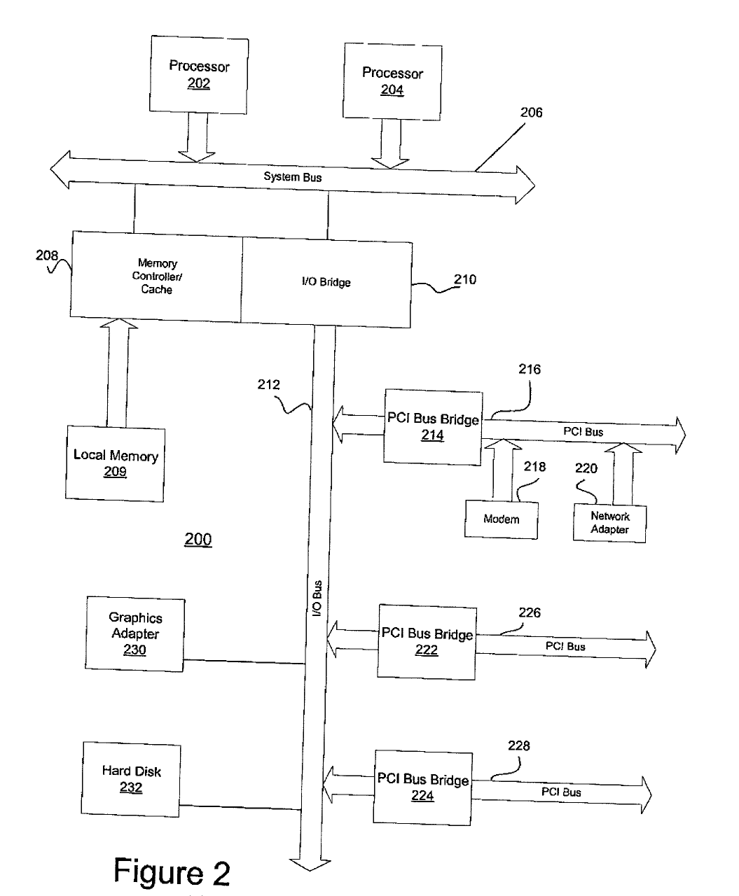

FIG. 2 illustrates a block diagram of a data processing system which may be implemented as a server, such as server 104 in FIG. 1, in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000, a product of International Business Machines Corporation in Armonk, N.Y., running the Advanced Interactive Executive (AIX) operating system.

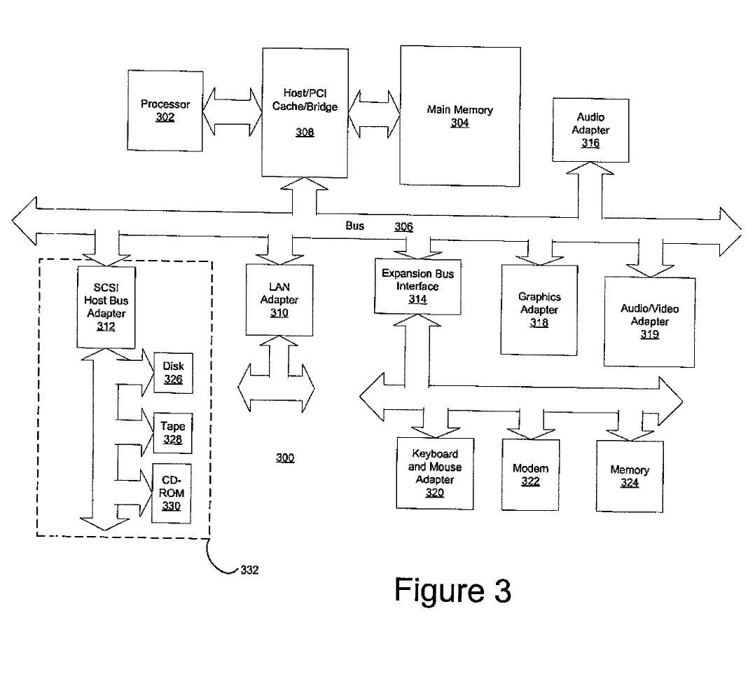

FIG. 3 illustrates a block diagram of a data processing system in which the present invention may be implemented. Data processing system 300 is an example of a client computer. Data processing system 300 employs a peripheral component interconnect (PCI) local bus architecture. Although the depicted example employs a PCI bus, other bus architectures, such as Micro Channel or ISA, may be used.

Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection.

In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324.

In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. Windows is a trademark of Microsoft Corporation. In a preferred embodiment, the operating system is a UNIX-type operating system.

An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

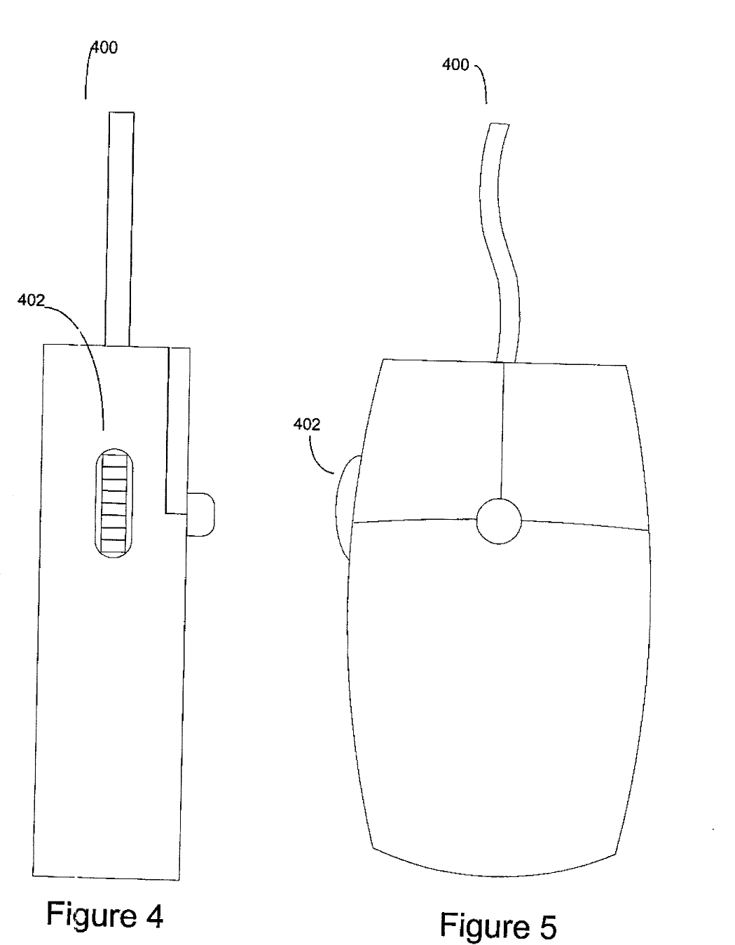

FIG. 4 is a side view of a mouse 400 which includes an audio control device 402 in accordance with the present invention. FIG. 5 is a top view of the mouse of FIG. 4 in accordance with the present invention. Mouse 400 may be utilized with any of the data processing systems depicted in FIGS. 1-3.

Audio control device 402 is included on a side of mouse 400. Audio control device 402 is preferably implemented as a moveable wheel, such as a thumb-wheel.

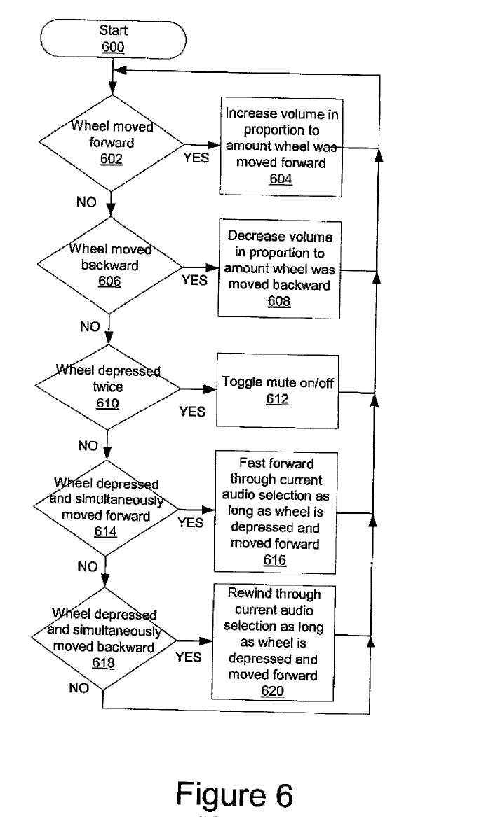

FIG. 6 is a high level flow chart which depicts utilizing an audio control device included within a mouse in accordance with the present invention. The process starts as depicted by block 600 and thereafter passes to block 602 which illustrates a determination of whether or not the audio wheel has been moved forward. If a determination is made that the audio wheel has been moved forward, the process passes to block 604 which depicts increasing the volume in proportion to the amount the wheel was moved forward. The process then passes back to block 602.

Referring again to block 602, if a determination is made that the audio wheel has not been moved forward, the process passes to block 606 which illustrates a determination of whether or not the wheel has been moved backward. If a determination is made that the wheel has been moved backward, the process passes to block 608 which depicts decreasing the volume in proportion to the amount the wheel was moved backward. The process then passes back to block 602.

Referring again to block 606, if a determination is made that the audio wheel has not been moved backward, the process passes to block 610 which illustrates a determination of whether or not the wheel has been depressed twice quickly and consecutively. If a determination is made that the wheel has been depressed twice quickly and consecutively, the process passes to block 612 which depicts toggling the mute on/off. The process then passes back to block 602.

Referring again to block 610, if a determination is made that the audio wheel has not been depressed twice quickly and consecutively, the process passes to block 614 which illustrates a determination of whether or not the wheel has been depressed while being simultaneously moved forward. If a determination is made that the wheel has been depressed while being simultaneously moved forward, the process passes to block 616 which depicts fast forwarding through the current audio selection as long as the wheel is being depressed and moved forward. The process then passes back to block 602.

Referring again to block 614, if a determination is made that the audio wheel has not been depressed while being simultaneously moved forward, the process passes to block 618 which illustrates a determination of whether or not the wheel has been depressed while being simultaneously moved backward. If a determination is made that the wheel has been depressed while being simultaneously moved backward, the process passes to block 620 which depicts rewinding through the current audio selection as long as the wheel is being depressed and moved backward. The process then passes back to block 602.

Referring again to block 618, if a determination is made that the audio wheel has not been depressed while being simultaneously moved backward, the process passes back to block 602.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system input pointing device comprising:
a single control device included within said input pointing device; and
said single control device for controlling an audio output of said data processing system in response to a movement of said control device.

2. The device according to claim 1, wherein said control device further comprises an audio wheel.

3. The device according to claim 1, further comprising:
said control device capable of being moved forward; and
means for increasing a volume of said audio output in proportion to an amount said control device is moved forward.

4. The device according to claim 1, further comprising:
said control device capable of being moved backward; and
means for decreasing a volume of said audio output in proportion to an amount said control device is moved forward.

5. The device according to claim 1, further comprising:
said control device capable of being depressed; and
means for toggling a mute of said audio output in response to said control device being depressed twice in quick succession.

6. The device according to claim 1, further comprising:
said control device capable of being depressed and moved forward; and
means for fast forwarding through a current audio selection while said control device is depressed while simultaneously being moved forward.

7. The device according to claim 1, further comprising:
said control device capable of being depressed and moved backward; and
means for rewinding through a current audio selection while said control device is depressed while simultaneously being moved backward.

8. The device according to claim 1, wherein said input pointing device is a mouse.

9. The device according to claim 1, wherein said control device is an audio wheel included on a side of said input pointing device.

10. A mouse for use in a data processing system, said mouse comprising:
a single audio wheel included on a side of said mouse; and
said audio wheel for controlling said audio output of said data processing system in response to a movement of said audio wheel.

11. The mouse according to claim 10, further comprising said single audio wheel capable of increasing a volume, decreasing said volume, toggling a mute of said volume, fast forwarding through a current audio selection, and rewinding through said current audio selection.

12. A method in a data processing system comprising the steps of:
providing an input pointing device;
including an audio control device on said input pointing device; and
controlling an audio output of said data processing system in response to a movement of said audio control device.

13. The method according to claim 12, further comprising the steps of:
moving said audio control device forward; and
increasing a volume of said audio output in proportion to an amount said audio control device is moved forward.

14. The method according to claim 12, further comprising:
moving said audio control device backward; and
decreasing a volume of said audio output in proportion to an amount said audio control device is moved forward.

15. The method according to claim 12, further comprising:
depressing said audio control device; and
toggling a mute of said audio output in response to said audio control device being depressed twice in quick succession.

16. The method according to claim 12, further comprising:
depressing while simultaneously moving said audio control device forward; and
fast forwarding through a current audio selection while said audio control device is depressed and simultaneously moved forward.

17. The method according to claim 12, further comprising:
depressing while simultaneously moving said audio control device backward; and
means for rewinding through a current audio selection while said audio control device is depressed and simultaneously moved backward.

18. A method in a data processing system comprising the steps of:
providing an input pointing device;
including a single audio wheel on a side said input pointing device; and
controlling a volume, toggling of a mute of said volume, fast forwarding through a current audio selection, and rewinding through said current audio selection utilizing said single audio wheel.
